(19) United States
(12) Patent Application Publication
(10) Pub. No.: US 2016/0231416 A1
(43) Pub. Date: Aug. 11, 2016

(54) METHOD AND SYSTEM FOR DETERMINING A RECEPTION CONFIGURATION AND A DURATION OF A TIME INTERVAL

(71) Applicant: THALES, Courbevoie (FR)

(72) Inventors: Hadrien GLAUDE, Elancourt (FR); Hubert BOUCARD, Elancourt (FR)

(21) Appl. No.: 15/024,011

(22) PCT Filed: Sep. 17, 2014
(86) PCT No.: PCT/EP2014/069804

§ 371 Date: Mar. 22, 2016

(30) Foreign Application Priority Data
Oct. 4, 2013 (FR) 1302310

(51) Int. Cl. G01S 7/02

(52) U.S. Cl. CPC G01S 7/021

(57) ABSTRACT

A method and system for determining, at a given instant, an optimal reception configuration and an optimal duration of a time interval is provided. The method comprises a first step of initializing a probability of reception associated with each of the different signals and further comprises the following iterative steps: a second step of determining two sets of signals, a third step of determining associated with each reception configuration, an optimal duration during which to use this configuration, a fourth step of determining, the optimal reception configuration of the values of the reception parameters, and steps of new probabilities of reception of the signals.

The present invention relates to a system and a method for determining reception instants and the reception parameters that a receiver must use for receiving different signals presenting periodicities. These signals are, for example, signals transmitted by a radar using a plurality of frequencies.

Systems are known in the prior art using wideband receivers and which therefore enable receiving signals at each instant, whatever the modulation frequency used by the transmission system. However, these receivers offer a sensitivity, defined as the ability to receive weak signals or distant signals, that is low.

For remedying this low sensitivity, it is known to use a receiver whereof the reception frequency bandspread is low, also known under the expression superheterodyne receiver or controllable reception frequency receiver. A superheterodyne receiver is a receiver designed on the principle of frequency mixing, or heterodyning, for converting the received signal into a lower intermediate frequency, which is easier to use than the directly received frequency. These receivers are, however, selective in frequency. In addition, according to the reception antenna the receiver, reception antenna pair, may also be spatially selective (compared to the bearing or elevation angle made by the direction of arrival of the radar signal), in the polarization or dynamics of the power of the radar signal received. In the event of using this type of receiver, it is then necessary to perform a scan of all the frequencies, directions of arrival, and different polarizations. Thus at a given instant the receiver may only receive the signals adapted to its instantaneous configuration.

In the prior art it is known that, before using the system, the different parameters that the receiver uses at a given moment are to be determined. However, this type of system does not allow adaptation to events that may occur during its use, such as, for example, pausing the process of receiving the signals.

The subject matter of the present invention is therefore a method and a system for determining the different parameters (reception frequency, angle of arrival, polarization) that a receiver, e.g. a superheterodyne, must use for receiving a signal transmitted by a radar transmitter.

Thus the invention provides a method for determining, at a given instant, an optimal reception configuration of a signal receiver, including at least one reception frequency, and an optimal duration of a time interval during which this optimal reception configuration is used in order to receive a plurality of different and repetitive signals from among a set of M signals. The method comprises a first step of initializing a probability of reception associated with each of the different signals, and the following iterative steps:

a second step of determining from among the set of M signals, implemented on a signal receiver, a first set of C least received signals and a second set of C′ least received signals, the number of elements of sets C and C′ being between 1 and M,

a third step of determining, implemented on said signal receiver, associated with each reception configuration, an optimal duration during which to use this configuration, said optimal duration being the duration maximizing a ratio between:
on the one hand a weighted sum of an increase in the probability of reception, associated with each of the signals of said first set of C least received signals, obtained using said configuration during said duration and
on the other hand said duration,

a fourth step of determining, implemented on said signal receiver, said optimal reception configuration of the values of said reception parameters,

the optimal reception configuration being the reception configuration maximizing a ratio between:
on the one hand a weighted sum of the increases in the reception probabilities, associated with each of the signals of said second set of C′ least received signals, obtained using said optimal reception configuration during said optimal duration and
on the other hand said optimal duration,

a fifth step of determining, implemented on said signal receiver, a value of said increase in the probabilities of reception, associated with the signals other than the signals of the first or second set, using said optimal reception configuration and performing this reception during said optimal duration,

a sixth step of updating said probability of reception, implemented on said signal receiver, associated with each of the signals based on the increases in the probabilities,

a seventh step of reception, using said optimal reception configuration and said optimal duration.

Advantageously, the first step is further adapted for initializing the tables associated with all or part of the signals and containing information representative of said receptions already performed.

Advantageously, the third determining step is further adapted for updating said tables associated with all or part of the signals of said first set.

Advantageously, the fourth determining step is further adapted for updating said tables associated with all or part of the signals of said second set.

Advantageously, the fifth determining step is further adapted for updating said tables associated with all or part of the signals belonging neither to said first set nor to said second set.

Advantageously, the updating of said tables is performed based on:

durations, associated with said signals, of a time interval allowing the detection of the presence of said signal if the step of reception is performed using a combination of reception parameters capable of receiving this signal during one of these time intervals, and/or,

periods of repetition, associated with said signals, of said time interval and/or,

durations, associated with said signals, of a time interval of transmission of said signal and/or,

durations, associated with said signals, at the end of which the future presence of said signal no longer depends on its presence at this instant.

The invention also relates to a system of reception of a plurality of different and periodic signals comprising:

at least one signal receiver,

at least one processor coupled to the memory, said processor being capable of implementing the method according to one of claims 1 through 5 and of setting the parameters of said receiver.

Advantageously, the receiver is a controllable reception frequency receiver.

Advantageously, the receiver is a multiple channel receiver, for which a reception band is obtained by the association of several small reception band channels and for which the frequency band to be listened to is adjustable by means of switching onto one of said channels.

Advantageously, the receiver is a superheterodyne receiver.

The invention will be better understood and other advantages will emerge on reading the detailed description, given as a non-restrictive example and with the aid of the figures in which:

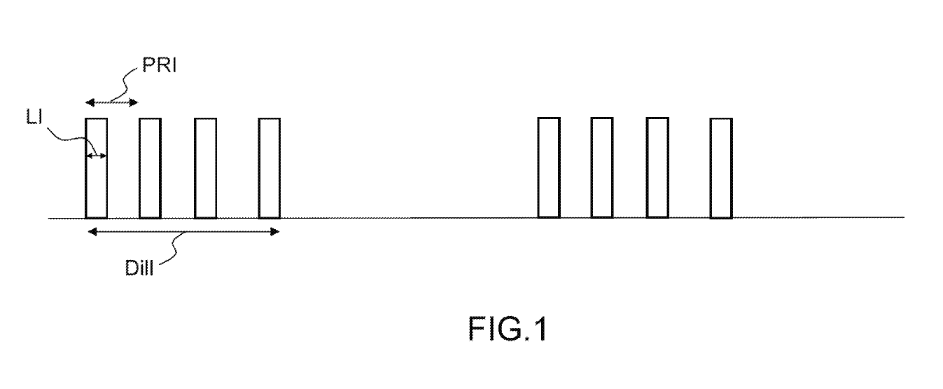

FIG. 1 presents the signals that the method of the invention may detect

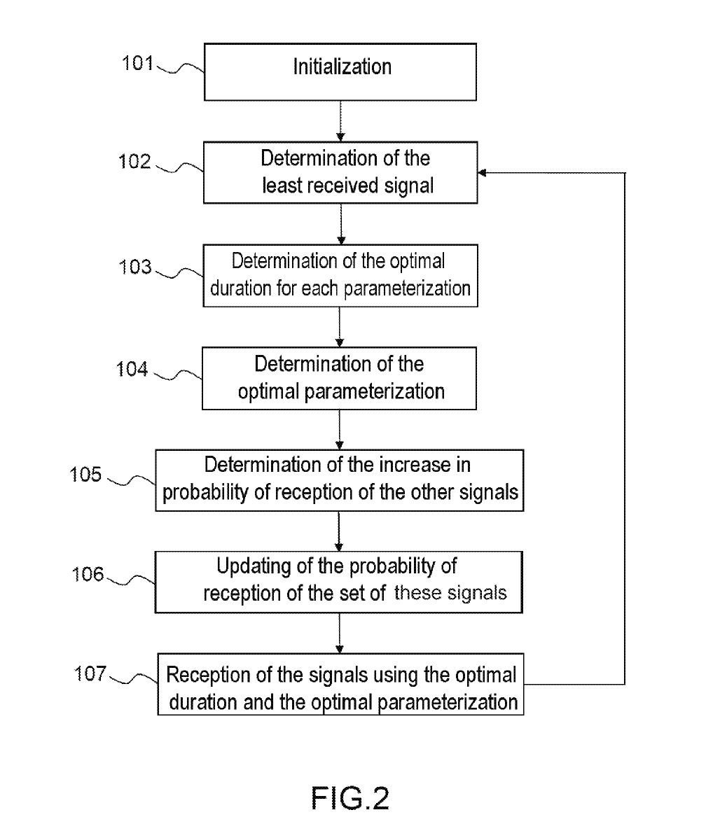

FIG. 2 presents the method set out in the invention

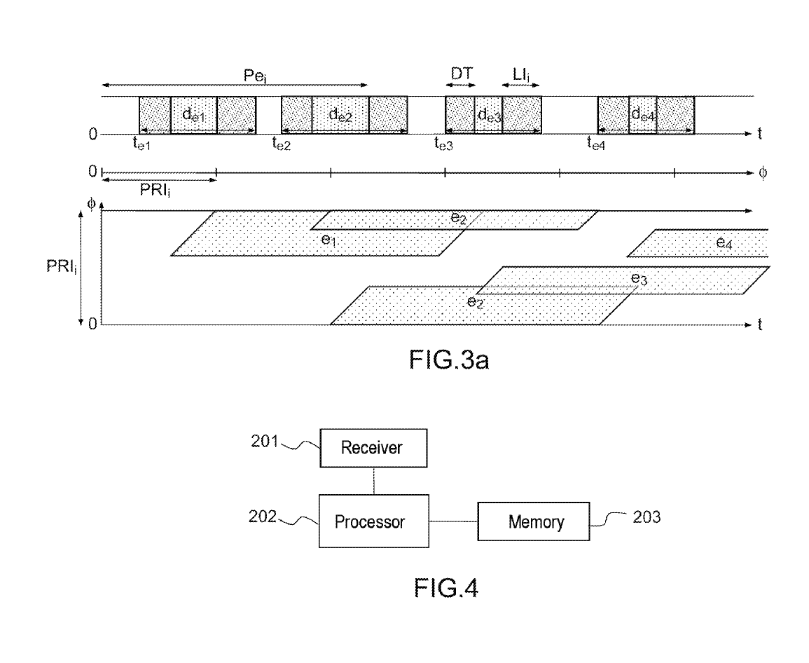

FIG. 3.a presents an example of phase space and time

FIG. 3.b presents an example of phase space

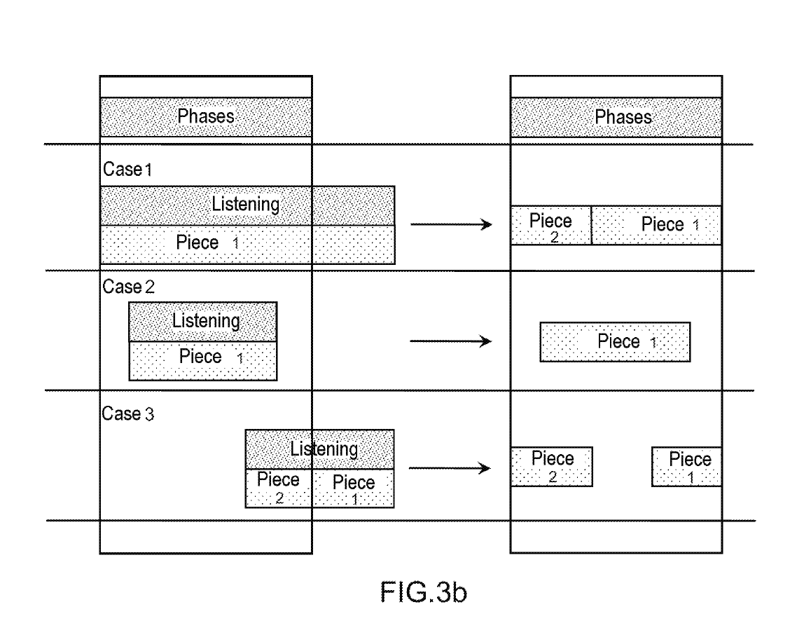

FIG. 4 presents the system set out in the invention

FIG. 1 presents the type of signals for which the method is used for determining reception parameters. These signals which are, for example, radar signals have the following characteristics:
Each signal presents time intervals that allow the detection of the presence of this signal if the receiver is configured for receiving this signal during one of these time intervals. The duration of these time intervals is denoted by LI and is known before using the method.
Each signal presents a repetition of these intervals during which detection is possible. The period of repetition of these time intervals is known before using the method and is denoted by PRI.
Each signal presents time intervals during which the signal is not transmitted to the antenna and others during which the signal is transmitted to the antenna. The average duration of these time intervals is known and is denoted by Dill.
The signal presents a maximum duration, at the end of which the future presence of this signal no longer depends on its presence at this instant. The maximum duration is the duration of illumination (Dill) reduced by the duration of analysis using the algorithm of the invention (Dana). The revisit period is denoted by Pe=Dill−Dana. Thus at the date t, all the listenings performed before t−Pe have no impact on the probability of intercepting the signal sufficiently early for launching an analysis at this date t.

FIG. 2 presents the method for determining, at a given instant, a configuration, to be used by a receiver, and a duration of a time interval, during which to use this configuration in order to receive a plurality of different and repetitive signals from among a set of M signals: the method comprising:

a first step 101 of initializing a probability of reception associated with each of the different signals.

This initialization may be performed, for example, and in a non-restrictive way, by setting the set of probabilities of reception associated with each of the different signals to zero. In other embodiments it is possible to initialize the values of the probabilities to a predetermined value. This may, for example, be useful in the case where the method is started in a known state.

The method then comprises the following iterative steps:
A second step 102 of determining from among the set of M signals a first set of C least received signals and a second set of C′ least received signals, the number of elements of sets C and C′ being between 1 and M.
C has a value between 1 and M (the number of signal types) with a preferred value of M.
C′ has a value between 1 and M with a preferred value of 1.
The method then comprises a third step 103 of determining, associated with each reception configuration of the receiver, an optimal duration during which to use this configuration, said optimal duration being the duration maximizing a ratio between:
   on the one hand a weighted sum of the increases in the probability of reception, the increases being associated with each of the signals of said first set of C least received signals and obtained using said configuration during said duration and
   on the other hand said duration.
The method then comprises a fourth step 104 of determining, an optimal configuration of the receiver, the optimal configuration being the configuration maximizing a ratio between:
   on the one hand a weighted sum of the increases in the probabilities of reception, the increases being associated with each of the signals of said second set of C′ least received signals and obtained using said configuration during the optimal duration and
   on the other hand said optimal duration.
The method then comprises a fifth step 105 of determining a value of the increase in the probabilities of reception associated with the signals other than the signals of the first or second set, using said optimal configuration and performing this reception during the optimal duration.
The method then comprises a sixth step 106 of updating the probabilities of reception associated with each of the signals based on the increases in the probabilities.
The method finally comprises a seventh step 107 of reception using the optimal configuration and the optimal duration.

Thus the method of the invention seeks to maximize the time average of the probability of reception of the different periodic signals. Each periodic signal is associated with a configuration of the receiver which is defined as being a value set of different parameters used for receiving the signals. The signals are in particular characterized by the following parameters:

the duration of the time intervals allowing detection (LI), this duration corresponds to the pulse width of the signal (LI),

the period of repetition of these time intervals (PRI),

the duration during which the receiver may receive the transmitted signal (Dill),

the transmission frequency (f)

and the rotation period of the transmission antenna (PRA).

In one embodiment, the third, fourth and fifth steps use a database comprising the characteristics of different signals to be detected. This library is constructed from the information of all types collected before using this method. This database may contain the three main parameters for setting the parameters of the signal:

the duration of the time intervals allowing detection (LI),

the period of repetition of these time intervals (PRI) and

the duration during which the receiver may receive the transmitted signal (Dill).

The objective of this method is to maximize a weighted average of these probabilities. The calculation of the time average of the probability of reception of the signals is performed via the calculation of the probability of interception or PoI. The probability of interception as a function of time, PoI_{M}(t), is the probability of detecting at least one signal pulse M in a lobe ending at the date t. A lobe passage corresponds to the moment when the signal may be received. Dill indicates the duration of said moment.

To do this, the method provides for determining, for a given instant, the configuration for performing this reception of the signals and the duration of the time interval during which to use this configuration (the expression listening sequence is also used for designating a series of time intervals each associated with a set of listening parameters). This determination is performed with the flow of the procedure: thus, at each end of an interval of reception of the signal, the parameters used for reception in the next interval are determined, knowing the parameters used in the preceding intervals. That is to say, the duration and the optimal configuration of the receiver are determined for the next reception interval.

In one embodiment the method uses tables, or lists of pairs, associated with the signals and containing information representative of the receptions already performed using a configuration allowing the signal to be received. These tables are also called phase space and time or phase space tables.

The first step 101 is in an embodiment adapted for initializing the phase space and time and performed by setting the values of the information representative of the receptions already performed using a configuration allowing the signal to be received.

The third step 103 of determining the optimal listening duration, associated with each configuration of the receiver, may be performed using the following relationship:

$${d}_{l} = {argmax}_{d} \frac{{G}_{l}^{E} ( d )}{d}$$

In this relationship:

dₗ is the optimal listening duration associated with a configuration l of the receiver.

Gₗ^{E}(d) is the weighted sum of the increase in the probability of reception of the signals of the first set. This increase in the probability of reception is obtained by performing a reception during the duration d, and by using the value l of the configuration of the receiver. This increase is given by the formula:

$${G}_{l}^{E} ( d ) = {\sum }_{i = 1}^{C} {w}_{i} {G}_{l}^{E , i} ( d )$$

### Where:

Gₗ^{E,i}(d) is the increase in the probability of reception of the signal i, obtained by performing a reception during the duration d, and by using the value l of the configuration of the receiver.
wᵢ: is a weighting coefficient representing the influence that the signal i has to have. This parameter is defined by the user. It may represent the probability of the presence of this signal or the danger level of the latter. The higher this parameter is, the greater will be the probability of interception of this signal, after using the algorithm.
C: represents the number of least received signals which are taken into account for calculating the weighted sum.
E: represents the listening sequence already performed.

As Gₗ^{E,i}(d) is a piecewise linear function with a finite number of pieces, then the maximum of

$$\frac{{G}_{l}^{E} ( d )}{d}$$

may only be found in a finite number of points (the non-linearity points of the function Gₗ^{E,i}(d)).

These points are determined using the following algorithm, which can be used to calculate the increase in the probabilities of reception of the signal i, for a configuration of a receiver l, from a listening e starting at instant tₑ and during d. Φ_{l,i} represents the phase space, associated with the signal i and covered by the preceding listenings using the configuration l of the receiver. dₚ is the duration of the preceding listening performed. This duration is zero if the preceding listening was performed with a configuration different from that of the current configuration. The returned result is the analytical representation of the gain function Gₗ^{E,i}(d) as a function of the listening duration d. As the gains are piecewise linear, they are represented by a finite list Gₗ^{E,i} of triplets (αₘ, aₘ, bₘ), m ∈ N. Each triplet represents the gain Gₗ^{E,i}(d)=αₘ*d+bₘ over the interval d ∈ [αₘ; αₘ+1].

In the rest of the method the following variables are used:
t′ₑ=date of the next change of slope of the curve. This date increases progressively through phase space x time.
dₑ=duration of listening until the next change of slope.
Slope=the new slope of the gain function.
Origin=ordinate of the gain curve piece extended to the abscissa O.
Sum=value of the gain curve at the change of slope.
bound which represents the maximum listening duration after which the slope of the gain curve is always equal to one. This variable stops looping in the phase space.

In addition the expression a←b means that the value b is saved in the memory a.

If dₚ=0 (the last listening was performed with a different configuration), then the following operations are performed:

t′ₑ←tₑ+DT

bound←DT+LIᵢPRIᵢ

d←DT+LIᵢ

Gₗ^{E,i}←{(0,0,0)}

Else, the following operations are performed:

bound←DT+LIᵢ+PRIᵢ−dₚ

In addition, if dₚ≧DT+LIᵢ+PRIᵢ then the following operation is performed:

Gₗ^{E,i}←{(0,1,0), (PRIᵢ, 1, 0)}

Else, if dₚ≧DT+LIᵢ then the following two operations are performed:

t′ₑ←tₑ−LIᵢ

d←0

Finally, if neither of the two preceding conditions is fulfilled the following three operations are performed:

t′ₑ←tₑ+DT

d←DT+LIᵢ−dₚ

Gₗ^{E,i}←{(0,0,0)}

Then, the following operations are performed:

Sum←0

φₑ←t′ₑ mod PRIᵢ

Then (a, b) ∈ Φ_{l, i} is chosen such that a is the largest possible and that a≠φₑ.

shift←φₑ−a

slope←min{Pₑ, t′ₑ−shift−b}/PRIᵢ

origin←−slope*d

Gₗ^{E,i}=Gₗ^{E,i}∪{(d, slope, origin)}

(a, b)←successor of (a, b) in Φ_{l,i}

Δφ←a−φₑ

If Δφ≠0 then the following operation is performed:

Δφ←Δφ+PRIᵢ

d←d+Δφ

sum←Δφ*slope

slope←min{Pₑ, t′ₑ+d−li−b}/PRIᵢ

The algorithm then comprises the following repetitive steps which are performed as long as d<bound:

origin←sum−slope*d

Gₗ^{E,i}←Gₗ^{E,i}∪{(d, slope, origin)}

m←a

(a, b)←successor of (a, b) in φ_{l,i}

Δφ←a−m

If Δφ≠0 then the following operation is performed:

Δφ←Δφ+PRIᵢ

d←d+Δφ

If d<bound then the following two operations are performed:

sum<Δφ*slope

slope←min{Pₑ, t′ₑ+d−li−b}/PRIᵢ

Then, the following operations are performed:

sum←(bound−(d−Δφ))*slope

d←bound

slope←1

origin←sum−slope*d

Gₗ^{E,i}=Gₗ^{E,i}∪{(d, slope, origin)}

In other words, in the case where the last listening has been performed with a different configuration (dₚ=0), the algorithm will update the following variables by looping on the rectangles of the phase space.

The algorithm then presents the following three steps:
1. The variables are initialized and the first point is added to the curve, namely the point corresponding to the triplet (αₘ, aₘ, bₘ)=(0,0,0). Thus the gain function is zero until the next point, which can be used to model the presence of the dead time, which is the time during which the system cannot receive signals since it is in the process of configuration.
2. The next rectangle is sought in the phase space according to the date of the start of listening.
3. Looping is performed on the rectangles of the phase space in the direction of time, until reaching a duration greater than the bound, by updating the variables described above and by adding the point (de, slope, origin) to the curve.

When the gain is calculated for the extension of an already existing listening (dₚ is then different from 0), the gain curve is the same as that of the different listening, except that it is shifted by −dₚ on the abscissa and as much as necessary on the ordinate so that the gain is zero at 0. The algorithm therefore remains the same, once the variables are correctly initialized for taking this shift into account.

As indicated previously, the phase space represents the set of listenings that have already been performed for a given type of signal. Thus, for each configuration of the receiver, knowledge of the signals which are detectable by the receiver is used for updating the phase space of these signals.

The updating of this phase space is obtained by folding back each listening in the phase interval ranging from 0 to PRI. This folding back is carried out in order to take into account the periodicity of value PRI of the signal. This updating is illustrated in FIG. 3. At the top of this figure, the listenings already performed for a given mode are represented on the time axis t. In addition, on each listening, the useful part of the listening (of duration dₑ_{ᵢ}) is isolated by subtracting the dead time (DT) and the pulse width (LIᵢ). In this way, the pulse start dates tₑ_{ᵢ} that could be intercepted with this listening are obtained. At the bottom, each parallelogram is associated with a listening e_{i,} and represents, for this listening, the points (lobe start date, phase of the pulse train in the lobe) for which the listening would have intercepted at least one pulse.

This updating of the phase space, φ_{l,i} associated with the signal i, is implemented by the addition of listenings eᵢ. The listenings must be added in order (the last programmed are added last). This space is represented by an ordered set of pairs (a, b) . That is, two successive pairs (a, b), (c, d) . Two consecutive pairs (a, b), (c, d) mean that one or more listenings have been performed which may intercept the illuminations that are not yet completed, whereof the start date is less than b+Φ_{l,i}−a and whereof the phase is between a and c. Φ_{l,i} is the illumination phase. The part whereof the phase is included in the interval [a; c] and whereof the time is less than b is occupied by the listenings. Finally, the successor of the last pair is defined as being the first pair. Thus Φ_{l,i} therefore always contains a pair.

The operations to be performed are as follows:

t′ₑ←tₑ+DT

Thus the useful part of the listening is calculated, i.e. after the dead time.

g′ₑ←tₑ+d−LIᵢ

The useful part of the listening is calculated. g′ₑ is the end date of useful listening, i.e. after leaving the time of intercepting a pulse entirely. In other words if a pulse, of duration LI, begins at g′ₑ it will be intercepted entirely by listening since the latter actually ends at g′ₑ+LI.

Ψₑ←mod PRIᵢ Ψₑ represents the end of listening phase

If g′ₑ−t′ₑ≧PRIᵢ then the following operation is performed (case where listening covers the whole phase space):

Φ_{l,i}←{(0, g′ₑ−Ψₑ), (Ψₑ, g′ₑ−PRIᵢ)}

Else, if g′ₑ>t′ₑ then the following two operations are performed:

Φₑ←t′ₑ mod PRIᵢ Φₑ represents the start of listening phase

If Ψₑ>Φₑ (if the listening has a useful part) then for all (a, b) ∈Φ_{l,i} the following instructions are performed:

If g′ₑ−b≧Pₑ then the following operation is performed:

b←−28

If a≦Ψₑ then the following operations are performed:

m←a+(Ψₑ−b)

If a≧Φₑ then the following operation is performed:

Φ_{l,i}←Φ_{l,i}\{(a, b)} the pair (a, b) is removed from Φ_{l,i}.

Φ_{l,i}←Φ_{l,i}∪{(Φₑ, t′ₑ), (Ψ′ₑ, m)}.

Else, in the case where in the phase space the listening forms two blocks, the following operations are performed:

For all (a, b) ∈Φ_{l,i} the following instructions are performed:

If g′ₑ−b≧Pₑ then the following operation is performed:

b←−∞

If a>Φₑ then the following operation is performed:

Φ_{l,i}←Φ_{l,i}\{(a, b)} the pair (a, b) is removed from Φ_{l,i}.

If a≦Ψₑ then the following two operations are performed:

m←b+Ψₑ−a)

Φ_{l,i}←Φ_{l,i}\{(a, b)}

Φ_{l,i}←Φ_{l,i}∪{(Φₑ, t′ₑ), (Ψₑ, m), (0, t′ₑ+PRIᵢ−Φₑ)}

Then only the successive pairs are kept whereof the time component equals −∞.

In other words and as illustrated in FIG. 3.a, the phase space may be represented as being composed of parallelograms. Seen from the right and straightening the parallelograms to make rectangles of them, the phase space may be described by a piecewise constant function evolving over [0; PRI]. It may therefore be represented in the form of a list of pairs. The time elapsed since the listening corresponding to the parallelogram corresponding to the piece is associated with each piece. If the elapsed time is greater than Pe (Pe is the revisit period), then it may be considered that the elapsed time is infinite.

The algorithm is therefore responsible for adding the piece or pieces corresponding to the parallelograms of a new listening. This is done by removing the covered pieces and the pieces that are “too old”. Several cases arise according to the duration and the instant of the new listening.

FIG. 3.b presents our algorithm in another way. In the case where the listening lasts more than one PRI then the entire phase space and time may be replaced by two pieces. In case 2 if the phase at the start of the listening is less than that at the end of the listening it is necessary to add only a single rectangle or piece in the phase space and time. In case 3 it is necessary to add two pieces.

It is then possible to calculate the value of

$$\frac{{G}_{l}^{E} ( d )}{d}$$

for each value of d=αₘ of the triplets.

Then the value dₗ is determined as being the value for which the value of

$$\frac{{G}_{l}^{E} ( d )}{d}$$

is maximum.

The third step 104 of determining an optimal configuration of the receiver may be performed using the following relationship:

$${l}_{opt} = {argmax}_{l} \frac{{G}_{l}^{E} ( {d}_{l} )}{{d}_{l}}$$

In this relationship:

dₗ is the optimal listening duration associated with a configuration l of the receiver.

Gₗ^{E}(d) is the weighted sum of the increase in the probability of reception of the signals of the first set. This increase in the probability of reception is obtained by performing a reception during the duration d, and by using the value l of the configuration of the receiver. This increase is given by the formula:

$${G}_{l}^{E} ( {d}_{l} ) = {\sum }_{i = 1}^{{C}^{′}} {w}_{i} {G}_{l}^{E , i} ( {d}_{l} )$$

### Where:

Gₗ^{E,i}(dₗ) is the increase in the probability of reception of the signal i, obtained by performing a reception during the duration d, and by using the value l of the configuration of the receiver.

wᵢ: is a weighting coefficient representing the influence that the signal i has to have. This parameter is defined by the user. The higher this parameter is, the greater the probability of interception of this signal.

C′: represents the number of least received signals that are considered

In the case where C′ is greater than C, the set of Gₗ^{E,i}(dₗ) will not have been calculated. In particular the elements for i ranging from C+1 to C′. It is therefore necessary to calculate these values. To do this, it is possible to use the same algorithm as for the preceding step.

Thus based on the finite list of triplets (αₘ , aₘ , bₘ),m ∈ N, each triplet representing over the interval d ∈ [αₘ; αₘ+1] the gain Gₗ^{E,i}(d)=aₘ*d+bₘ, it is possible to calculate Gₗ^{E,i}(dₗ) for each i ranging from C+1 to C′.

Thus it is possible to calculate the value of

$$\frac{{G}_{l}^{E} ( {d}_{l} )}{{d}_{l}}$$

for each configuration l of the receiver. As the number of configurations is finite the person skilled in the art may then determine the optimal configuration that maximizes

$$\frac{{G}_{l}^{E} ( {d}_{l} )}{{d}_{l}}$$

The determination of Gₗ_{ₒₚₜ}^{E,i}(dₗ_{ₒₚₜ}) is performed as during the third step 103, as well as the updating of the phase space.

Then the fifth step 105 is used for determining a value of the increase in the probabilities of reception, associated with the signals other than the signals of the first or second set. This determination is performed using the optimal configuration and performing this reception during said optimal duration.

This step is performed by calculating the value of Gₗ_{ₒₚₜ}^{E,i}(dₗ_{ₒₚₜ}) for the signals other than those of the first and second set. To do this, it is possible to use the algorithm of the third step.

The sixth step 106 of updating the probability of reception associated with each of the signals is performed based on the increases in the probabilities. To do this, the probability of reception obtained from a signal i, following the preceding listening, is incremented by a value which corresponds to the Gₗ_{ₒₚₜ}^{E,i}(dₗ_{ₒₚₜ}).

Finally the receiver is configured for performing a listening using the configuration lₒₚₜ and during a duration dₗ_{ₒₚₜ}.

FIG. 4 presents a system adapted to the use of this method. This system comprises a signal receiver 201 and a processor 202 coupled to the memory 203. The processor is capable of implementing the method previously presented and of setting the parameters of the signal receiver.

In one embodiment, the receiver is a controllable reception frequency receiver. Thus this receiver may, for example, be a multiple channel receiver, for which a reception band is obtained by the association of several small reception band channels and for which the frequency band to be listened to is adjustable by means of switching onto one of said channels. This may also be a signal receiver of the superheterodyne type.

1. A method for determining, at a given instant, an optimal reception configuration of a signal receiver, including at least one reception frequency, and an optimal duration of a time interval during which to use this optimal reception configuration in order to receive a plurality of different and repetitive signals from among a set of M signals, the method comprising:
a first step, implemented on a signal receiver, of initializing a probability of reception associated with each of the different signals, and the following iterative steps:
a second step implemented on said signal receiver, of determining from among the set of M signals a first set of C least received signals and a second set of C′ least received signals, the number of elements of sets C and C′ being between 1 and M,
a third step, implemented on said signal receiver, of determining, associated with each reception configuration, an optimal duration during which to use this configuration, said optimal duration being the duration maximizing a ratio between:
on the one hand a weighted sum of an increase in the probability of reception, associated with each of the signals of said first set of C least received signals, obtained using said configuration during said duration and
on the other hand said duration,
a fourth step, implemented on said signal receiver, of determining, said optimal reception configuration of the values of said reception parameters, said optimal reception configuration being the reception configuration maximizing a ratio between:
on the one hand a weighted sum of the increases in the reception probabilities, associated with each of the signals of said second set of C′ least received signals, obtained using said optimal reception configuration during said optimal duration and
on the other hand said optimal duration,
a fifth step, implemented on said signal receiver, of determining a value of said increase in the probabilities of reception, associated with the signals other than the signals of the first or second set, using said optimal reception configuration and performing this reception during said optimal duration,
a sixth step, implemented on said signal receiver, of updating the probability of reception associated with each of the signals based on the increases in the probabilities,
a seventh step of reception using said optimal reception configuration and said optimal duration.

2. The method of determination as claimed in claim 1, wherein:
said first step is further adapted for initializing tables associated with all or part of the signals and containing information representative of said receptions already performed.

3. The method of determination as claimed in claim 2, wherein:
said third determining step is further adapted for updating said tables associated with all or part of the signals of said first set.

4. The method of determination as claimed in claim 2 wherein:
said fourth determining step is further adapted for updating said tables associated with all or part of the signals of said second set.

5. The method of determination as claimed in claim 2, wherein:
said fifth determining step is further adapted for updating said tables associated with all or part of the signals belonging neither to said first set nor to said second set.

6. The method of determination as claimed in claim 3, wherein said updating of said tables is performed based on:
durations, associated with said signals, of a time interval allowing the detection of the presence of said signal if the step of reception is performed using a combination of reception parameters capable of receiving this signal during one of these time intervals, and/or,
periods of repetition, associated with said signals, of said time interval and/or,
durations, associated with said signals, of a time interval of transmission of said signal and/or,
durations, associated with said signals, at the end of which the future presence of said signal no longer depends on its presence at this instant.

7. A system of reception of a plurality of different and periodic signals comprising:
at least one signal receiver, at least one processor coupled to the memory, said processor being capable of implementing the method as claimed in claim 1 and of setting the parameters of said receiver.

8. The system as claimed in claim 7, wherein said receiver is a controllable reception frequency receiver.

9. The system as claimed in claim 7, wherein said receiver is a multiple channel receiver, for which a reception band is obtained by the association of several small reception band channels and for which the frequency band to be listened to is adjustable by means of switching onto one of said channels.

10. The system as claimed in claim 7, wherein said receiver is a superheterodyne receiver.
